(19) United States
(12) Patent Application Publication
(10) Pub. No.: US 2020/0065860 A1
(43) Pub. Date: Feb. 27, 2020

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Shinji ICHIKAWA, Nagoya-shi (JP); Harunobu SAITO, Nagoya-shi (JP); Daiki KANEICHI, Nisshin-shi (JP); Ryotaro FUJIWARA, Tokyo-to (JP); Megumi AMANO, Toyota-shi (JP); Masato ENDO, Nagakute-shi (JP); Tae SUGIMURA, Miyoshi-shi (JP)

(73) Assignee: TOYOTA JIDOSHA KABUSHIKI KAISHA, Toyota-shi (JP)

(21) Appl. No.: 16/550,380

(22) Filed: Aug. 26, 2019

(30) Foreign Application Priority Data
Aug. 24, 2018 (JP) 2018-157478

(51) Int. Cl. G06Q 30/02; G06K 9/00; H04W 4/44

(52) U.S. Cl. CPC G06Q 30/0266; H04W 4/44; G06K 9/00671; G06K 9/00201

(57) ABSTRACT

An information processing apparatus comprises a controller configured to execute detecting approach of a vehicle to an advertisement to be displayed; and providing stimulus relevant to the advertisement to any one or more of five senses other than a visual sense of a person in the vehicle if the approach of the vehicle to the advertisement is detected.

### CROSS REFERENCE TO THE RELATED APPLICATION

This application claims the benefit of Japanese Patent Application No. 2018-157478, filed on Aug. 24, 2018, which is hereby incorporated by reference herein in its entirety.

### BACKGROUND

### Technical Field

The present disclosure relates to an information processing apparatus, an information processing method, and a non-transitory storage medium.

### Description of the Related Art

In recent years, a technique, which enhances the power of an advertisement to appeal to customers, is developed. Patent Literature 1 discloses a technique which relates to an interactive advertisement based on information previously set by a user.

### PRIOR ART LITERATURE

### Patent Literature

Patent Literature 1: Japanese Patent Application Laid-Open No. 2014-135058

### SUMMARY

An object of the present disclosure is to provide a technique which stimulates any one or more of the five senses other than the visual sense of a person so that the power of an advertisement to appeal to customers is enhanced.

A first aspect of the present disclosure may reside in an information processing apparatus comprising a controller configured to execute:

detecting approach of a vehicle to an advertisement to be displayed; and

providing a stimulus relevant to the advertisement to any one or more of five senses other than a visual sense of a person in the vehicle if the approach of the vehicle to the advertisement is detected.

A second aspect of the present disclosure may reside in an information processing method comprising:

detecting approach of a vehicle to an advertisement to be displayed; and

providing a stimulus relevant to the advertisement to any one or more of five senses other than a visual sense of a person in the vehicle if the approach of the vehicle to the advertisement is detected.

A third aspect of the present disclosure may reside in a non-transitory storage medium storing a program for allowing a computer to execute:

detecting approach of a vehicle to an advertisement to be displayed; and

providing a stimulus relevant to the advertisement to any one or more of five senses other than a visual sense of a person in the vehicle if the approach of the vehicle to the advertisement is detected.

According to the present disclosure, it is possible to provide the technique which stimulates any one or more of the five senses other than the visual sense of a person so that the power of the advertisement to appeal to customers is enhanced.

### BRIEF DESCRIPTION OF THE DRAWINGS

FIG. 1 shows an exemplary outline of configuration of an advertisement display system according to a first embodiment.

FIG. 2 shows an exemplary outline of a structure of a blower.

FIG. 3 shows an exemplary outline of functional configuration of a digital signage.

FIG. 4 shows an exemplary outline of a table included in advertisement information DB.

FIG. 5 shows an exemplary outline of functional configuration of a controller of the blower.

FIG. 6 shows an exemplary flow chart for allowing the digital signage to execute a process for sending a control signal to rotate a fan of the blower.

FIG. 7 shows an exemplary flow chart of a process executed when a request signal for requesting cartridge ID is received by the blower from an external apparatus.

FIG. 8 shows an exemplary flow chart of a process executed when a control signal for controlling rotation of the fan is received by the blower from an external apparatus.

FIG. 9 shows an exemplary operation of the advertisement display system when an advertisement of a flower shop is displayed on a display of the digital signage.

FIG. 10 shows an exemplary situation in which a vehicle approaches the digital signage.

FIG. 11 shows an exemplary outline of an advertisement display system for blowing an odor to a vehicle from the vicinity of an advertisement display place when the approach of the vehicle is detected.

FIG. 12 shows an exemplary outline of functional configuration of a blower.

FIG. 13 shows an exemplary flow chart for executing a process in which fans are rotated to diffuse the flower odor to the outside when the blower detects the approaching vehicle.

FIG. 14 shows an exemplary outline of configuration of an advertisement display system according to a second embodiment.

FIG. 15 shows an exemplary outline of functional configuration of a digital signage.

FIG. 16 shows an exemplary outline of a table including in advertisement information DB.

FIG. 17 shows an exemplary outline of functional configuration of a car audio.

FIG. 18 shows an exemplary flow chart for executing a process in which the digital signage sends an acoustic signal of a piece of music relevant to an advertisement displayed on a display.

FIG. 19 shows an exemplary flow chart of an operation of the car audio.

FIG. 20 shows an exemplary outline of an operation flow of the car audio when the advertisement, which is displayed on the display of the digital signage, is an advertisement relevant to a new song of a singer.

FIG. 21 shows an exemplary outline of an advertisement display system according to a modified embodiment of the second embodiment.

FIG. 22 shows an exemplary outline of functional configuration of a car audio.

FIG. 23 shows an exemplary outline of a table included in piece of music information DB.

FIG. 24 shows an exemplary flow chart for executing a process in which the car audio outputs an acoustic signal of a piece of music relevant to an advertisement displayed on a display of a digital signage.

FIG. 25 shows an exemplary outline to depict a situation in which the piece of music relevant to the advertisement displayed on the display resounds throughout the interior of a vehicle by the aid of the car audio.

### DESCRIPTION OF THE EMBODIMENTS

An advertisement, which is displayed, for example, on a signboard or a display of a digital signage, is sometimes noticed from the interior of a vehicle which is traveling. However, if the advertisement is, for example, an advertisement relevant to a newly released piece of music, a person, who has noticed the advertisement, desires to listen to the displayed new song to know what kind of song it is. However, it is impossible to listen to the displayed new song then and there. On the other hand, if the advertisement is, for example, an advertisement relevant to a flower sold in a flower shop, a person, who has noticed the advertisement, desires to smell the odor to know what kind of odor hangs in the air from the displayed flower. However, it is impossible to smell the odor of the displayed flower then and there. That is, when the advertisement is merely displayed, the power of the advertisement to appeal to customers is low.

Taking the foregoing circumstances into consideration, the information processing apparatus according to the embodiment of the present disclosure enhances the power of the advertisement to appeal to customers by stimulating any one or more of the five senses other than the visual sense of a person.

A first aspect of the present disclosure may reside in an information processing apparatus comprising a controller which executes:

detecting approach of a vehicle to an advertisement to be displayed; and

providing a stimulus relevant to the advertisement to any one or more of five senses other than a visual sense of a person in the vehicle if the approach of the vehicle to the advertisement is detected.

In this context, the stimulus relevant to the advertisement, which is provided to any one or more of the five senses other than the visual sense, is an odor which recalls a flower if the advertisement is, for example, an advertisement relevant to the flower. Further, the stimulus is a sound if the advertisement is, for example, an advertisement relevant to the music. Further, the stimulus is an odor which recalls a food and/or a drink if the advertisement is, for example, an advertisement relevant to the food and/or the drink.

The information processing apparatus as described above makes it possible to provide the stimulus relevant to the display content to one or more of the five senses other than the visual sense, in addition to the fact that a consumer, who notices the advertisement, is allowed to recognize the information displayed on the advertisement by the aid of the visual sense. Therefore, the information processing apparatus as described above makes it possible to enhance the power of the advertisement to appeal to customers as compared with such a case that the advertisement is merely displayed.

### <First Embodiment

### (System Configuration)

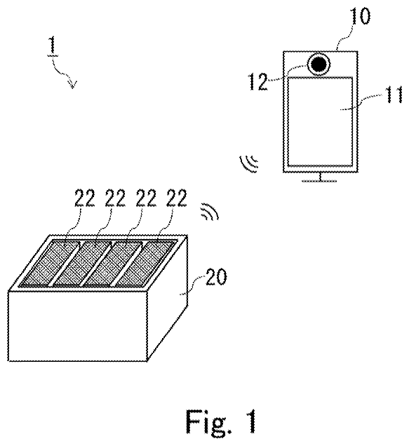

FIG. 1 shows an exemplary outline of configuration of an advertisement display system 1 according to a first embodiment. The advertisement display system 1 according to this embodiment is formed by a digital signage 10 and a blower 20. In this context, the digital signage 10 is an example of the “information processing apparatus” of the present disclosure.

The digital signage 10 is an apparatus for displaying the advertisement famed by screen images and/or letters or characters. The digital signage 10 may be installed, for example, at any place which has a large traffic volume of people and vehicles including, for example, station yards, wall surfaces of buildings in business districts or downtowns, and areas along main roads. The digital signage 10 is provided with a display 11 on which the advertisement is displayed, and a camera module 12 which is disposed over the display 11. The camera module 12 is used to detect any approaching vehicle.

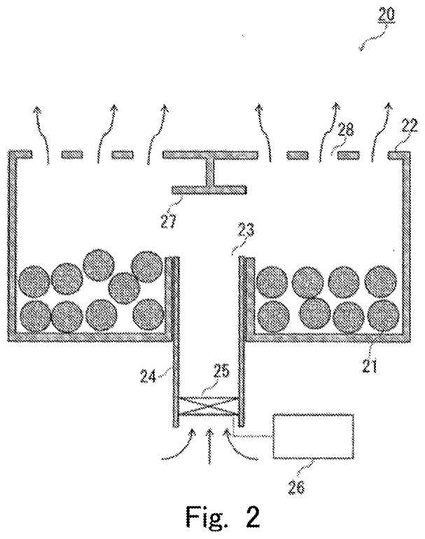

The blower 20 is an apparatus which is carried, for example, on a vehicle and which allows the odor to blow into the interior of the vehicle. FIG. 2 shows an exemplary outline illustrating a schematic structure of the blower 20. The blower is provided with a cartridge 22 which includes an odor substance 21. The odor substance 21 is stored or accumulated at the bottom of the cartridge 22. The odor substance 21 is, for example, a substance which emits a flower odor. However, the odor substance 21 is not limited to the substance which emits the flower odor. The odor substance 21 may be a substance which emits a plant odor or a substance which emits an odor of a food and/or a drink. Further, the number of cartridge 22 or cartridges 22 provided for the blower 20 is not limited. Furthermore, it is also allowable to use different odor substances 21 for the respective cartridges 22.

Further, as shown in FIG. 2, the cartridge 22 has an opening 23 which is provided at a central lower portion. Then, the blower 20 is provided with a blast tube passage 24 which is inserted into the opening 23 of the cartridge 22. Then, the blower 20 has a fan 25 which is provided at an intermediate position of each blast tube passage 24 and which allows the air to blow into the interior of the cartridge 22. Then, the blower 20 is provided with a controller 26 which controls the number of revolutions of vanes provided for the fan 25. Further, a diffusion plate 27, which diffuses the air allowed to flow into the interior of the cartridge 22 via the blast tube passage 24, is provided over the opening 23 at the inside of the cartridge 22. Further, the blower 20 is provided with outflow holes 28 through which the air in the cartridge 22 containing the odor substance 21 flows out to the outside of the system.

In the advertisement display system 1 according to this embodiment, the digital signage 10 and the blower 20 are connected to one another by means of the wireless communication. The wireless communication includes, for example, Wi-Fi (registered trademark), Bluetooth (registered trademark), and infrared communication.

### (Functional Configuration)

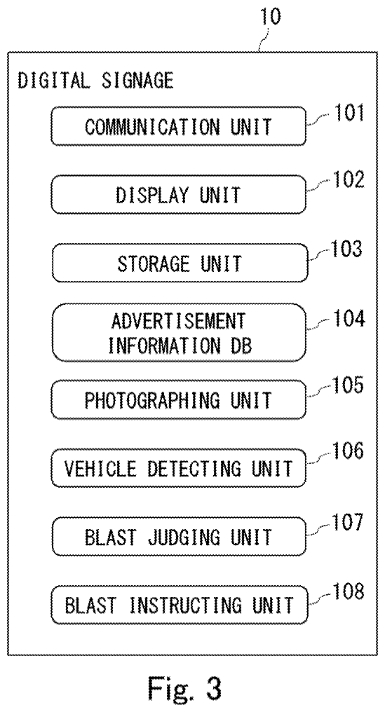

FIG. 3 shows an exemplary outline of functional configuration of the digital signage 10. The digital signage 10 is an apparatus which has a processor such as CPU and the like, a main storage device such as RAM, ROM and the like, EPROM, a hard disk drive, the display 11, and the camera module 12. The display 11 is famed, for example, by a liquid crystal display or an organic EL display. Further, an TED matrix or a projector may be also available in place of the display. For example, an operating system (OS) and various programs are stored in the auxiliary storage device. The program stored therein is loaded to and executed in an operation area of the main storage device, and respective configuration units and the like are controlled in accordance with the execution of the program. Thus, it is possible to realize respective functions which conform to a predetermined purpose as described later on.

The digital signage 10 is provided with a communication unit 101. The communication unit 101 is a wireless communication interface for connecting the digital signage 10 by means of the wireless communication.

Further, the digital signage 10 is provided with a display unit 102. The display unit 102 displays the image information on the display 11.

Further, the digital signage 10 is provided with a storage unit 103. The storage unit 103 is configured to include the main storage device and the auxiliary storage device. The main storage device is a memory for developing the program executed by the processor and the data utilized by the control program. The auxiliary storage device is a device for storing the program executed by the processor and the data utilized by the control program. The auxiliary storage device may store the operating system for executing the program. The function as described above is realized by loading the program stored in the auxiliary storage device to the main storage device and executing the program by the processor.

Further, the digital signage 10 includes an advertisement information database (DB) 104 for storing the information relevant to the advertisement displayed on the display 11. The advertisement information DB 104 is constructed such that the program of the database management system, which is executed by the processor, manages the data stored in the storage unit 103. The advertisement information DB 104 is, for example, a relational database.

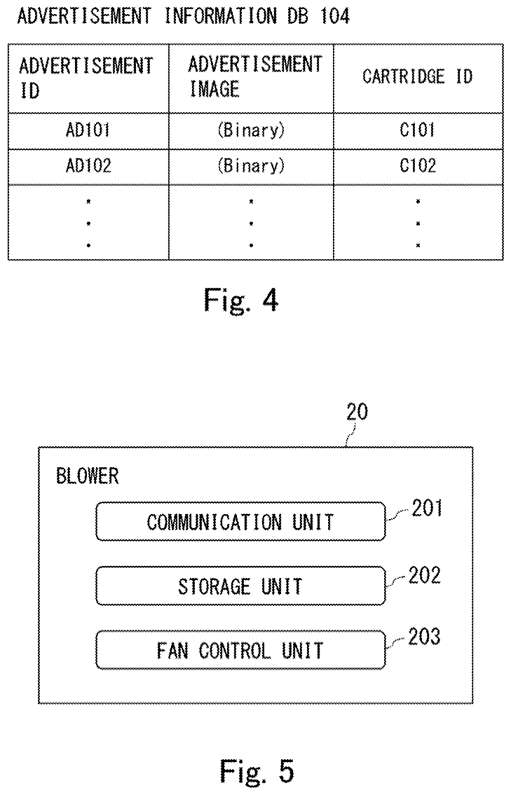

FIG. 4 shows an exemplary outline of a table included in the advertisement information DB 104. As shown in FIG. 4, the advertisement information DB 104 stores “advertisement ID” (Identification) for distinguishing the advertisement, “advertisement image information”, and “cartridge ID” of the cartridge containing the odor substance 21 relevant to the display matter to be displayed on the advertisement.

Further, the digital signage 10 is provided with a photographing unit 105. The photographing unit 105 controls the photographing operation performed by the camera module 12. Further, the photographing unit 105 transmits the photographed image information to a vehicle detecting unit 106.

Further, the digital signage 10 is provided with the vehicle detecting unit 106. The vehicle detecting unit 106 distinguishes the vehicle from objects imaged in the image. A known image recognition technique is used for the distinguishing method.

Further, the digital signage 10 is provided with a blast judging unit 107 which judges whether or not the fan 25 of the blower 20 is rotated. The blast judging unit 107 extracts the information stored in the advertisement information DB 104 from the same DB. Further, the blast judging unit 107 acquires the cartridge ID provided for the blower 20. That is, the blast judging unit 107 judges whether or not the fan 25 of the blower 20 is rotated on the basis of the information stored in the advertisement information DB 104 and the cartridge ID information of the cartridge provided for the blower 20.

Further, the digital signage 10 is provided with a blast instructing unit 108 which instructs the blower 20 to rotate the fan 25. The blast instructing unit 108 generates a control signal for controlling the rotation of the fan 25 of the blower 20. The control signal includes signals which are relevant, for example, to the cartridge ID, the number of revolutions of the fan, and the rotation time of the fan.

Further, the processor possessed by the digital signage 10, which executes the program to realize the functions as described above, is an example of the “controller” of the present disclosure.

Next, an explanation will be made about the functional configuration of the controller 26 of the blower 20. FIG. 5 shows an exemplary outline of the functional configuration of the controller 26 of the blower 20. The controller 26 has a processor such as CPU and the like, a main storage device such as RAM, ROM and the like, EPROM, and an auxiliary storage device such as a hard disk drive, removable media and the like. For example, an operating system (OS), various programs, and various tables are stored in the auxiliary storage device. The program stored therein is loaded to and executed in an operation area of the main storage device, and respective configuration units and the like are controlled in accordance with the execution of the program. Thus, it is possible to realize respective functions which conform to a predetermined purpose as described later on.

The controller 26 is provided with a communication unit 201. The communication unit 201 is a wireless communication interface for connecting the controller 26 by means of the wireless communication. The communication unit 201 provides the access to the network, for example, by the aid of any mobile communication service including, for example, wireless LAN, 3G, LTE and the like.

Further, the controller 26 is provided with a storage unit 202. The storage unit 202 is configured to include the main storage device and the auxiliary storage device. The main storage device is a memory for developing the program executed by the processor and the data utilized by the control program. The auxiliary storage device is a device for storing the program executed by the processor and the data utilized by the control program. The auxiliary storage device may store the operating system for executing the program. The function as described above is realized by loading the program stored in the auxiliary storage device to the main storage device and executing the program by the processor. Further, the storage unit 202 stores the cartridge ID of the cartridge provided for the blower 20, for example, in the main storage device.

Further, the controller 26 is provided with a fan control unit 203. The fan control unit 203 controls the rotation of the fan 25 in accordance with the control signal for controlling the rotation of the fan 25. The control signal includes signals which are relevant, for example, to the cartridge ID, the number of revolutions of the fan, and the rotation time of the fan.

### (Process Flow of Respective Devices)

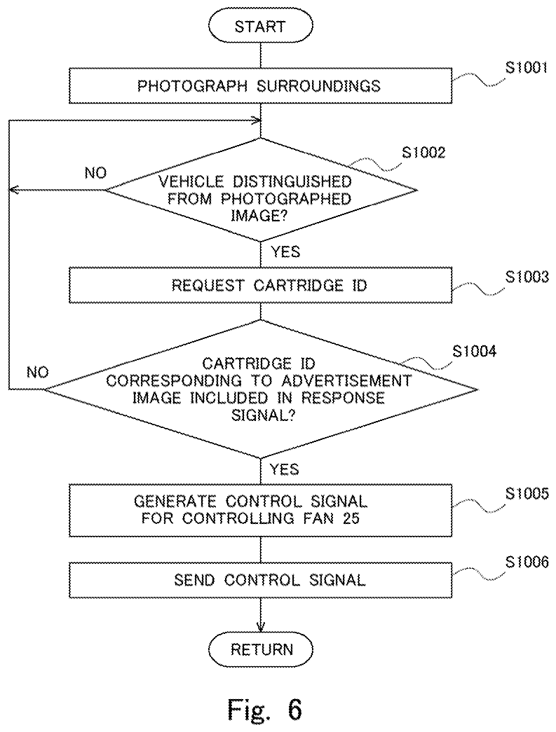

Next, an explanation will be made about a process flow executed by the respective devices. FIG. 6 shows an exemplary flow chart for allowing the digital signage 10 to execute a process for sending a control signal to rotate the fan 25 of the blower 20.

### (S1001)

In Step S1001, the display unit 102 outputs the advertisement image information. Further, the storage unit 103 temporarily stores, in the main storage device, the advertisement ID corresponding to the outputted advertisement image. Further, the photographing unit 105 executes the photographing operation, and the photographed image is transmitted to the vehicle detecting unit 106.

### (S1002)

In Step S1002, the vehicle detecting unit 106 distinguishes the object imaged in the image received from the photographing unit 105. Then, the vehicle detecting unit 106 judges whether or not the object is the vehicle which approaches the digital signage 10.

### (S1003)

In Step S1003, if the vehicle detecting unit 106 judges that the object imaged in the photographed image is the vehicle, the blast judging unit 107 sends the request signal for requesting the cartridge ID by the aid of the communication unit 101.

### (S1004)

In Step S1004, the blast judging unit 107 judges whether or not a response signal is received with respect to the request signal for requesting the cartridge ID. Then, if it is judged that the response signal is received with respect to the request signal for requesting the cartridge ID, the blast judging unit 107 judges whether or not the response signal includes the cartridge ID information. Then, if it is judged that the cartridge ID information is included in the response signal, the blast judging unit 107 acquires, from the main storage device, the advertisement ID information corresponding to the outputted advertisement image. Then, the blast judging unit 107 extracts, from the advertisement information DB 104, the cartridge ID information corresponding to the advertisement ID. That is, the blast judging unit 107 extracts, from the advertisement information DB 104, the cartridge ID information corresponding to the outputted advertisement image. Then, it is judged whether or not the cartridge ID information included in the response signal is included in the extracted cartridge ID information.

### (S1005)

In Step S1005, if the blast judging unit 107 judges that the cartridge ID information included in the response signal is included in the cartridge ID information extracted from the advertisement information DB 104, the blast instructing unit 108 generates the control signal for controlling the rotation of the fan. The control signal includes signals corresponding to the information relevant, for example, to the cartridge ID corresponding to the outputted advertisement image, the number of revolutions of the fan, and the rotation time of the fan.

### (S1006)

In Step S1006, the communication unit 101 sends the generated control signal for controlling the rotation of the fan to the device as the transmission source from which the response signal has been transmitted.

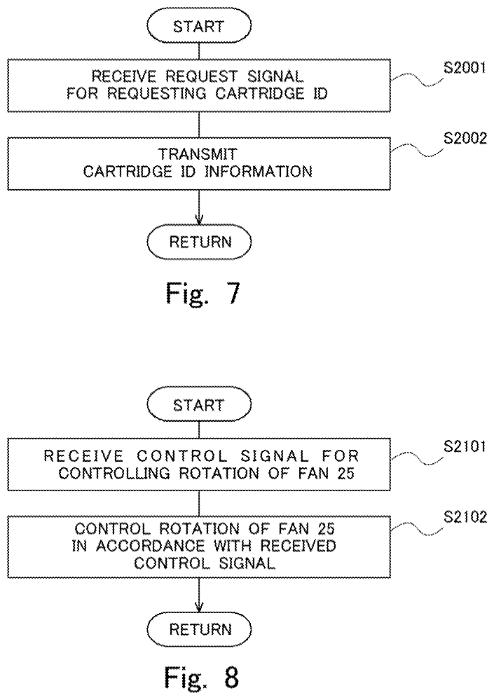

Further, FIG. 7 shows an exemplary flow chart of a process executed when a request signal for requesting the cartridge ID is received by the blower 20 from an external apparatus.

### (S2001)

In Step S2001, the communication unit 201 receives the request signal for requesting the cartridge ID from the external apparatus.

### (S2002)

In Step S2002, the communication unit 201 transmits the cartridge ID information stored, for example, in the main storage device to the transmission source of the request signal.

Further, FIG. 8 shows an exemplary flow chart of a process executed when a control signal for controlling rotation of the fan 25 is received by the blower 20 from an external apparatus.

### (S2101)

In Step S2101, the communication unit 201 receives the control signal for controlling the rotation of the fan 25 from the external apparatus. The control signal includes signals corresponding to the information which is relevant, for example, to the cartridge ID, the number of revolutions of the fan, and the rotation time of the fan.

### (S2102)

In Step S2102, the fan control unit 203 controls the rotation of the fan 25 for feeding the air into the cartridge 22 corresponding to the cartridge ID included in the received control signal, in accordance with the received control signal.

### (Exemplary Operation of Advertisement Display System 1)

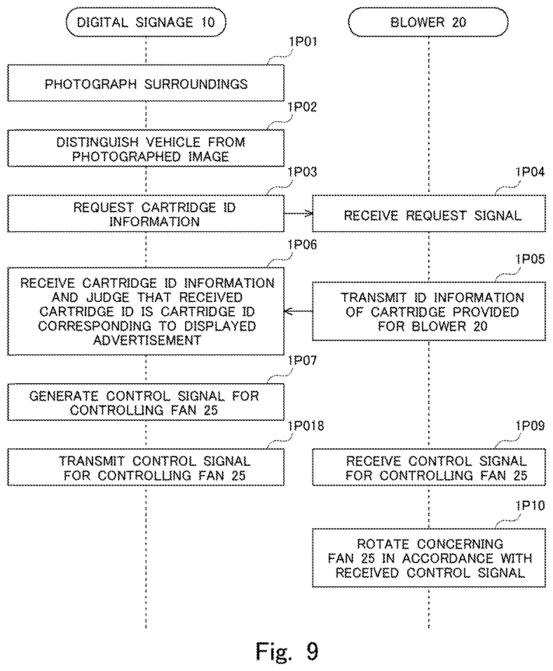

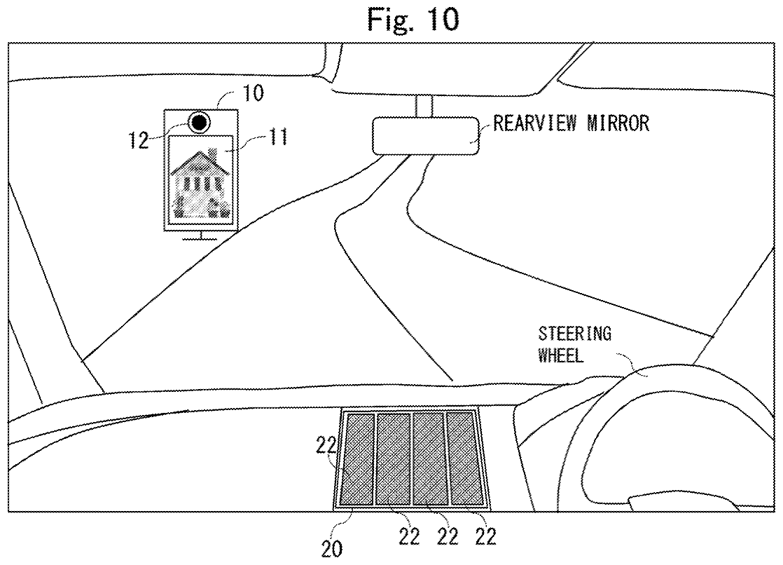

Next, an explanation will be made about an exemplary operation of the advertisement display system 1. FIG. 9 shows the exemplary operation of the advertisement display system 1 when an advertisement of a flower shop is displayed on the display 11 of the digital signage 10. Further, FIG. 10 shows an exemplary situation in which a vehicle approaches the digital signage 10. In this context, it is assumed that the blower 20 is installed in front of a driver's seat of the vehicle in a state in which the outflow holes 28 are directed to the interior of the vehicle. Further, it is assumed that the odor substance 21, which emits the odor of the flower corresponding to the advertisement of the flower shop displayed on the display 11, is contained in the cartridge provided for the blower 20.

### (Pattern 1P01)

The process of Step S1001 is executed, and the advertisement relevant to the flower is displayed on the display 11. Further, the advertisement ID, which distinguishes the advertisement displayed on the display 11, is temporarily stored in the main storage device. Further, the surroundings of the digital signage 10 are photographed, and the photographed image is transmitted to the vehicle detecting unit 106.

### (Pattern 1P02)

The process of Step S1002 is executed to judge whether or not the vehicle, which approaches the digital signage 10, is imaged in the photographed image.

### (Pattern 1P03)

If it is judged that the vehicle, which approaches the digital signage 10, is imaged in the photographed image, then the process of Step S1003 is executed, and the request signal for requesting the cartridge ID is sent by the aid of the communication unit 101.

### (Pattern 1P04)

The process of Step S2001 is executed, and the blower 20, which is installed on the vehicle that approaches the digital signage 10, receives the request signal for requesting the cartridge ID from the digital signage 10.

### (Pattern 1P05)

The process of Step S2002 is executed, and the cartridge ID information of the cartridge containing the odor substance 21 for emitting the flower odor is transmitted to the digital signage 10.

### (Pattern 1P06)

The process of Step S1004 is executed, and the blast judging unit 107 receives the response signal from the blower 20. Then, the blast judging unit 107 judges that the cartridge ID information is included in the received response signal. Further, the blast judging unit 107 acquires, from the main storage device, the advertisement ID information corresponding to the image of the flower displayed on the display 11. Then, the blast judging unit 107 extracts, from the advertisement information DB 104, the cartridge ID information corresponding to the advertisement ID. Then, the blast judging unit 107 judges that the cartridge ID, which is included in the received response signal, is included in the cartridge ID information extracted from the advertisement information DB 104.

### (Pattern 1P07)

The process of Step S1005 is executed, and the control signal for controlling the rotation of the fan 25 is generated. The control signal includes signals corresponding to the information relevant, for example, to the cartridge ID corresponding to the flower shop displayed on the display 11, the number of revolutions of the fan 25, and the rotation time of the fan 25, the cartridge ID being included in the response signal received in Pattern 1P06.

### (Pattern 1P08)

The process of Step S1006 is executed, and the generated control signal is transmitted to the blower 20.

### (Pattern 1P09)

The process of Step S2101 is executed, and the blower 20 receives, from the digital signage 10, the control signal for controlling the rotation of the fan 25. The control signal includes signals corresponding to the information relevant, for example, to the cartridge ID, the number of revolutions of the fan 25, and the rotation time of the fan 25.

### (Pattern 1P10)

The process of Step S2102 is executed, and the fan control unit 203 of the blower 20 controls the rotation of the fan 25 for feeding the air into the cartridge 22 corresponding to the cartridge ID included in the received control signal. The number of revolutions and the rotation time of the fan 25 are controlled in accordance with the received control signal.

### Effect of First Embodiment

In the advertisement display system 1 according to the first embodiment, when the digital signage 10 detects the approach of the vehicle, the control signal, which controls the rotation of the fan 25, is transmitted to the blower 20 carried on the approaching vehicle. Further, the fan 25, which is rotated in accordance with the control signal, is the fan which feeds the air into the cartridge for emitting the flower odor. That is, in the case of the advertisement display system 1 described above, the person, who, in the vehicle, notices the advertisement of the flow shop displayed on the digital signage 10, recognizes the advertisement of the flower shop by the aid of the olfactory sense (sense of smell), in addition to the recognition by the aid of the visual sense (sense of sight). That is, the advertisement display system 1 described above makes it possible to enhance the power of the advertisement to appeal to customers.

Further, the following system is also available. That is, if the owner of the vehicle, who notices the advertisement displayed on the advertisement display system 1 described above, purchases the merchandise displayed on the advertisement, the advertiser pays at least a part of the purchase expense of the cartridge 22. In the case of the system as described above, the desire is raised for the owner of the vehicle installed with the blower 20 to purchase the merchandise displayed on the advertisement.

### Modified Embodiment of First Embodiment

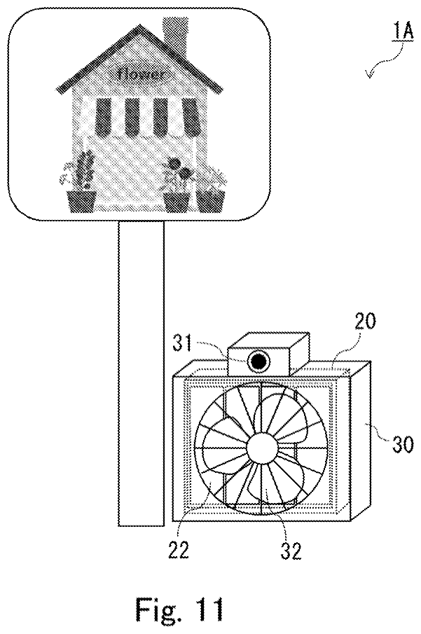

In the first embodiment, the flower odor, which is relevant to the advertisement of the flower shop displayed on the display 11, is allowed to blow into the interior of the vehicle from the blower 20 installed in the vehicle. However, the flower odor, which is relevant to the displayed advertisement, may be allowed to blow toward the vehicle from the vicinity of the display place of the advertisement. FIG. 11 shows an exemplary outline of an advertisement display system 1A for blowing an odor to a vehicle from the vicinity of an advertisement display place when the approach of the vehicle is detected. The advertisement display system 1A as described above is provided with a blower 30 which detects the vehicle and which blows the odor. The blower 30 is provided with a camera module 31 and a fan 32 which diffuses the odor toward the vehicle, in addition to a blower 20. In this context, the blower 30 is an example of the “information processing apparatus” of the present disclosure. Further, the blower 30 is installed in the vicinity of the display place of the advertisement. Further, the blower 30 includes a cartridge which contains the odor substance 21 for emitting the odor of the flower relevant to the flower shop displayed on the advertisement. Further, the blower 30 may include a cartridge for emitting an odor other than the flower odor. Further, as shown in FIG. 11, there is no limitation for the advertisement to be displayed on the display 11 of the digital signage 10. The advertisement may be displayed on a signboard.

### (Functional Configuration)

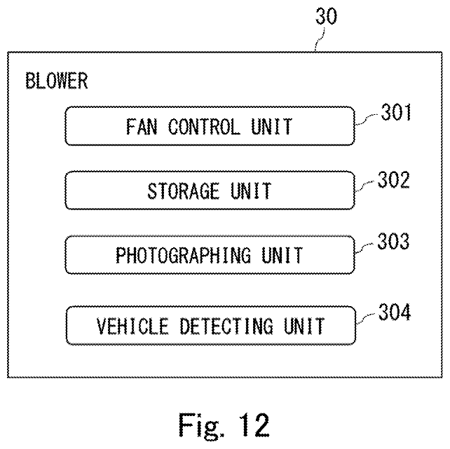

FIG. 12 shows an exemplary outline of functional configuration of the blower 30. The blower 30 is an apparatus which has a processor such as CPU and the like, a main storage device such as RAM, ROM and the like, EPROM, a hard disk drive, and the camera module 31. For example, an operating system (OS) and various programs are stored in the auxiliary storage device. The program stored therein is loaded to and executed in an operation area of the main storage device, and respective configuration units and the like are controlled in accordance with the execution of the program. Thus, it is possible to realize respective functions which conform to a predetermined purpose as described later on.

The blower 30 is provided with a fan control unit 301. The fan control unit 301 controls the rotation of the fan 25 in accordance with the control signal for controlling the rotation of the fan 25. The control signal includes signals which are relevant, for example, to the cartridge ID, the number of revolutions of the fan 25, and the rotation time of the fan 25. Further, the fan control unit 301 controls the rotation of the fan 32 in accordance with the control signal for controlling the rotation of the fan 32. The control signal includes signals which are relevant, for example, to the number of revolutions of the fan 32 and the rotation time of the fan 32.

Further, the blower 30 is provided with a storage unit 302. The storage unit 302 is configured to include the main storage device and the auxiliary storage device. The main storage device is a memory in which the program executed by the processor and the data utilized by the control program are developed. The auxiliary storage device is a device in which the program executed by the processor and the data utilized by the control program are stored. The auxiliary storage device may store the operating system in order to execute the program. The program stored in the auxiliary storage device is loaded to the main storage device, and the program is executed by the process. Thus, the function as described above is realized.

Further, the blower 30 is provided with a photographing unit 303. The photographing unit 303 controls the photographing operation performed by the camera module 31. Further, the photographing unit 303 transmits the photographed image information to a vehicle detecting unit 304.

Further, the blower 30 is provided with the vehicle detecting unit 304. The vehicle detecting unit 304 distinguishes the vehicle from objects imaged in the image. A known image recognition technique is used for the distinguishing method. Further, if the vehicle is distinguished, the vehicle detecting unit 304 generates the control signals for controlling the rotations of the fan 25 and the fan 32.

Further, the processor, which is possessed by the blower 30 to realized the functions by executing the programs, is an example of the “controller” of the present disclosure.

### (Process Flow of Vehicle Detecting Device)

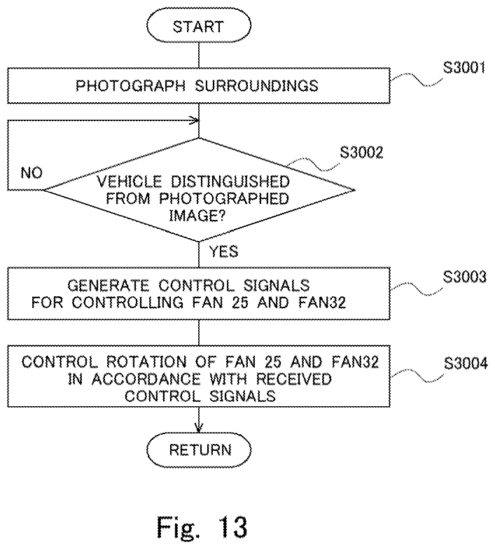

FIG. 13 shows an exemplary flow chart for executing a process in which the fan 25 and the fan 32 are rotated to diffuse the flower odor to the outside when the blower 30 detects the approaching vehicle.

### (S3001)

In Step S3001, the storage unit 302 stores the cartridge ID of the cartridge containing the odor substance 21 for emitting the flower odor in the main storage device and/or the auxiliary storage device. Further, the photographing unit 303 executes the photographing operation for photographing the surroundings of the blower 30, and the photographed image is transmitted to the vehicle detecting unit 304.

### (S3002)

In Step S3002, the vehicle detecting unit 304 distinguishes the object imaged in the image received from the photographing unit 303. Then, the vehicle detecting unit 304 judges whether or not the object is the vehicle which is approaching the advertisement.

### (S3003)

In Step S3003, if the vehicle detecting unit 304 judges that the object imaged in the photographed image is the vehicle which is approaching the advertisement, the control signals for controlling the rotations of the fan 25 and the fan 32 are generated. In this context, the vehicle detecting unit 304 makes reference to the cartridge ID information of the cartridge containing the odor substance 21 for emitting the flower odor stored in the main storage device and/or the auxiliary storage device to generate the control signal for controlling the rotation of the fan 25 for feeding the air into the cartridge. Then, the vehicle detecting unit 304 transmits the generated control signal to the fan control unit 301.

### (S3004)

In Step S3004, the fan control unit 301 controls the rotations of the fan 25 and the fan 32 in accordance with the received control signals. Thus, the air flows into the cartridge containing the odor substance 21 for emitting the flower odor. Then, the air in the cartridge flows out to the outside of the cartridge via the outflow holes 28. Then, the air is allowed to blow in the direction directed to the vehicle in accordance with the rotation of the fan 32.

Even in the case of the modified embodiment as described above, a person, who, in the vehicle, notices the advertisement of the flow shop displayed on the signboard, recognizes the advertisement of the flower shop by the aid of the olfactory sense (sense of smell), in addition to the recognition by the aid of the visual sense (sense of sight), in the same manner as in the first embodiment. That is, the advertisement display system 1A described above makes it possible to enhance the power of the advertisement to appeal to customers.

Further, in the embodiment described above, the content, which is displayed on the display 11 of the digital signage, relates to the flower. However, the content to be displayed is not limited to the above, which may relate, for example, to a food and/or a drink. Then, an odor, which is relevant to the food and/or the drink, may be emitted from the blower 20 and/or the blower 30. Even in the case of such a modified embodiment, a person, who notices the advertisement, recognizes the advertisement by the aid of the olfactory sense (sense of smell), in addition to the recognition by the aid of the visual sense (sense of sight), in the same manner as in the embodiment described above. Therefore, the power of the advertisement to appeal to customers is enhanced.

### Second Embodiment

### (System Configuration)

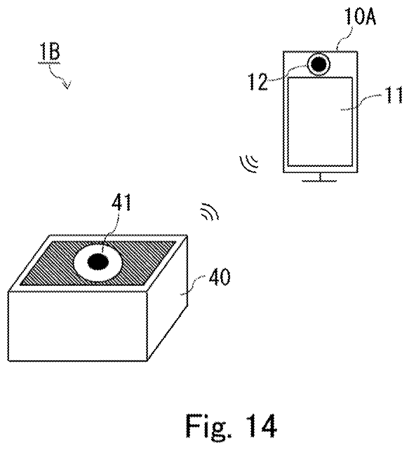

FIG. 14 shows an exemplary outline of configuration of an advertisement display system 1B according to a second embodiment. The advertisement display system 1B according to this embodiment is formed by a digital signage 10A and a car audio 40. The car audio 40 is provided with a speaker 41. In this context, the digital signage 10A is an example of the “information processing apparatus” of the present disclosure.

In the advertisement display system 1B according to this embodiment, the digital signage 10A and the car audio 40 are connected to one another by means of the wireless communication. The wireless communication includes, for example, Wi-Fi, Bluetooth, and infrared communication.

### (Functional Configuration)

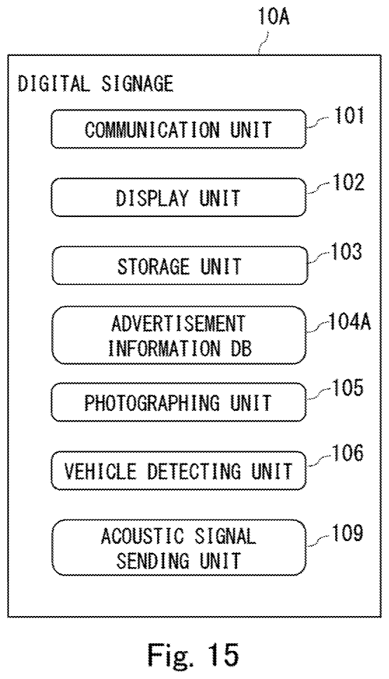

FIG. 15 shows an exemplary outline of functional configuration of the digital signage 10A. The digital signage 10A is provided with additional functions in addition to the functions which are the same as or equivalent to those of the digital signage 10. An explanation will be made below about the functions provided for the digital signage 10A, the functions being added to those of the digital signage 10.

The digital signage 10A includes an advertisement information database (DB) 104A for storing the piece of music information relevant to the advertisement displayed on the display 11. The advertisement information DB 104A is constructed such that the program of the database management system, which is executed by the processor, manages the data stored in the storage unit 103. The advertisement information DB 104A is, for example, a relational database.

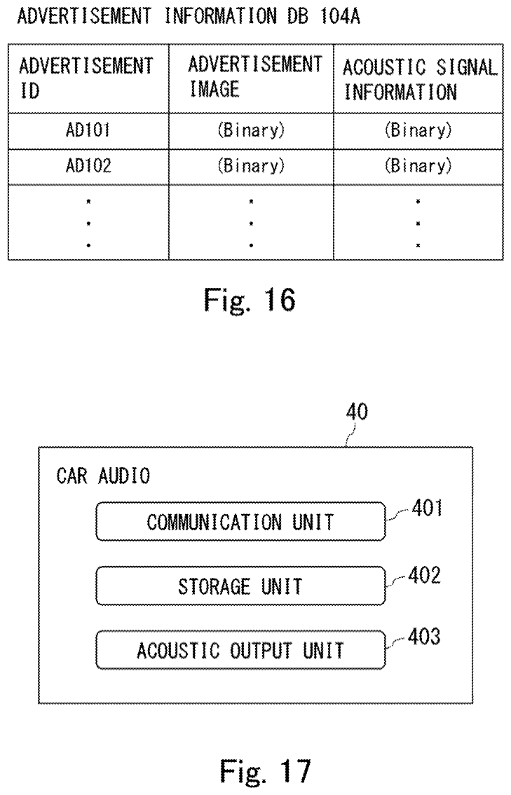

FIG. 16 shows an exemplary outline of a table included in the advertisement information DB 104A. As shown in FIG. 16, the advertisement information DB 104A stores “advertisement ID” for distinguishing the advertisement, “advertisement image information”, and “acoustic signal information” of the piece of music relevant to the advertisement.

Further, the digital signage 10A is provided with an acoustic signal sending unit 109. The acoustic signal sending unit 109 sends an acoustic signal by the aid of the communication unit 101.

Further, it is also allowable that the digital signage 10A is not provided with the advertisement information DB 104, the blast judging unit 107, and the blast instructing unit 108 which are provided for the digital signage 10.

Further, the processor possessed by the digital signage 10A, which executes the program to realize the functions as described above, is an example of the “controller” of the present disclosure.

Next, an explanation will be made about the functional configuration of the car audio 40. FIG. 17 shows an exemplary outline of the functional configuration of the car audio 40. The car audio 40 has a processor such as CPU and the like, a main storage device such as RAM, ROM and the like, EPROM, and an auxiliary storage device such as a hard disk drive, removable media and the like. For example, an operating system (OS), various programs, and various tables are stored in the auxiliary storage device. The program stored therein is loaded to and executed in an operation area of the main storage device, and respective configuration units and the like are controlled in accordance with the execution of the program. Thus, it is possible to realize respective functions which conform to a predetermined purpose as described later on.

The car audio 40 is provided with a communication unit 401. The communication unit 401 is a wireless communication interface for connecting the car audio 40 by means of the wireless communication.

Further, the car audio 40 is provided with a storage unit 402. The storage unit 402 is configured to include the main storage device and the auxiliary storage device. The main storage device is a memory for developing the program executed by the processor and the data utilized by the control program. The auxiliary storage device is a device for storing the program executed by the processor and the data utilized by the control program. The auxiliary storage device may store the operating system for executing the program. The function as described above is realized by loading the program stored in the auxiliary storage device to the main storage device and executing the program by the processor.

Further, the car audio 40 is provided with an acoustic output unit 403. The acoustic output unit 403 outputs the acoustic signal to resound the sound by the aid of the speaker 41.

### (Process Flow of Respective Devices)

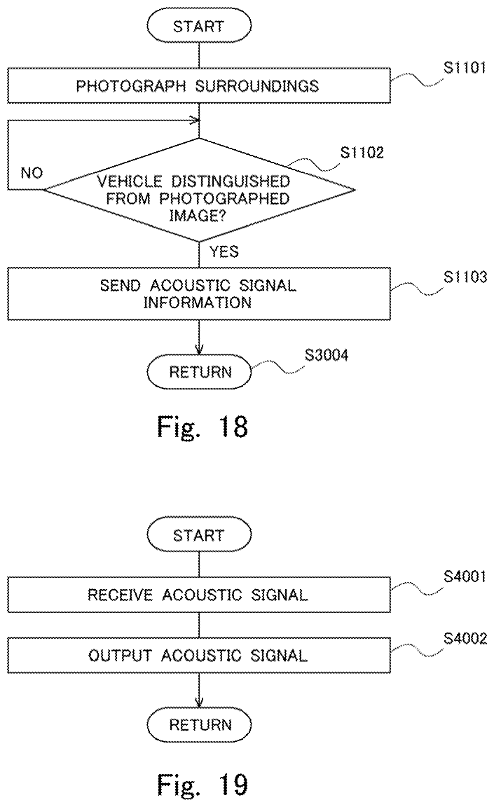

Next, an explanation will be made about a process flow executed by the respective devices. FIG. 18 shows an exemplary flow chart for executing a process in which the digital signage 10A sends an acoustic signal of a piece of music relevant to an advertisement displayed on the display 11.

### (S1101)

In Step S1101, the display unit 102 outputs the advertisement image information. Then, the advertisement image is displayed on the display 11. Further, the storage unit 103 temporarily stores, in the main storage device, the advertisement ID corresponding to the outputted advertisement image. Further, the photographing unit 105 photographs the surroundings of the digital signage 10A, and the photographed image is transmitted to the vehicle detecting unit 106.

### (S1102)

In Step S1102, the vehicle detecting unit 106 distinguishes the object imaged in the image received from the photographing unit 105. Then, the vehicle detecting unit 106 judges whether or not the object is the vehicle which approaches the digital signage 10A.

### (S1103)

In S1103, if the vehicle detecting unit 106 judges that the object imaged in the photographed image is the vehicle which approaches the digital signage 10A, the acoustic signal sending unit 109 extracts, from the advertisement information DB 104A, the acoustic signal information corresponding to the advertisement ID stored in the main storage device. Then, the acoustic signal sending unit 109 sends the extracted acoustic signal information by the aid of the communication unit 101.

Further, FIG. 19 shows an exemplary flow chart of an operation of the car audio 40.

### (S4001)

In Step S4001, the communication unit 401 receives the acoustic signal. In this embodiment, the communication unit 401 receives the acoustic signal sent from the digital signage 10A.

### (S4002)

In Step S4002, the acoustic output unit 403 outputs the received acoustic signal. That is, the sound, which relates to the displayed advertisement, resounds in the vehicle.

### Effect of Second Embodiment

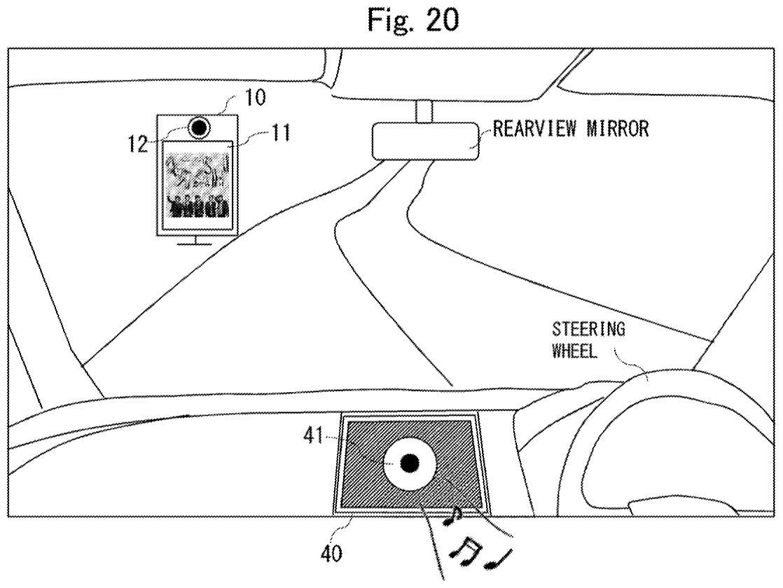

FIG. 20 shows an exemplary outline when the operation flow described above is executed when the advertisement, which is displayed on the display 11 of the digital signage 10A, is an advertisement relevant to a new song of a singer. As shown in FIG. 20, a person, who, in the vehicle, notices the advertisement relevant to the new song of the singer displayed on the display 11 of the digital signage 11, recognizes the advertisement of the new song by the aid of the acoustic sense (sense of hearing), in addition to the recognition by the aid of the visual sense (sense of sight). That is, the advertisement display system 1B described above makes it possible to enhance the power of the advertisement to appeal to customers.

Further, in the second embodiment, the car audio 40, which is installed for the vehicle, receives the acoustic signal from the digital signage 10A, and the car audio 40 resounds the piece of music in the vehicle. However, in place of the car audio 40, any information terminal such as a smartphone or a tablet terminal, which is provided with a speaker and a wireless communication interface, may receive the acoustic signal and resound the piece of music in the vehicle. Even in the case of the configuration as described above, it is possible to realize the operation of the advertisement display system 1B described above, and the power of the advertisement to appeal to customers is enhanced.

### Modified Embodiment of Second Embodiment

The second embodiment resides in such a form that the acoustic signal of the piece of music relevant to the advertisement displayed on the display 11 is sent from the digital signage 10A, and the car audio 40 receives the acoustic signal. However, the car audio may distinguish the content of the advertisement displayed on the digital signage 10A, and the acoustic signal may be generated and outputted on the basis of a result of distinction.

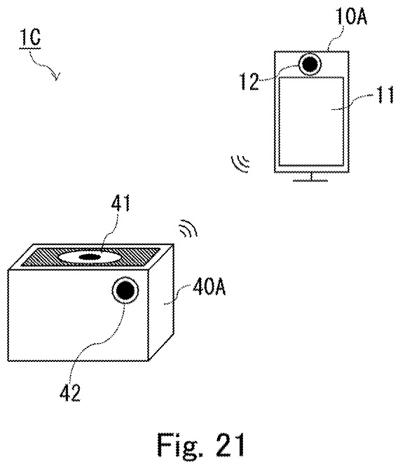

FIG. 21 shows an exemplary outline of an advertisement display system 1C according to a modified embodiment of the second embodiment. The advertisement display system 1C is formed by a digital signage 10A and a car audio 40A. The car audio 40A is provided with a camera module 42 which photographs the advertisement image displayed on the digital signage 10A, in addition to a speaker 41. Further, it is also allowable that the digital signage is not provided with the camera module. Alternatively, the digital signage may be provided with only the function to display the advertisement. In this context, the car audio 40A is an example of the “information processing apparatus” of the present disclosure.

In the advertisement display system 1C according to this embodiment, the digital signage 10A and the car audio 40A are connected to one another by means of the wireless communication. The wireless communication includes, for example, Wi-Fi, Bluetooth, and infrared communication.

### (Functional Configuration)

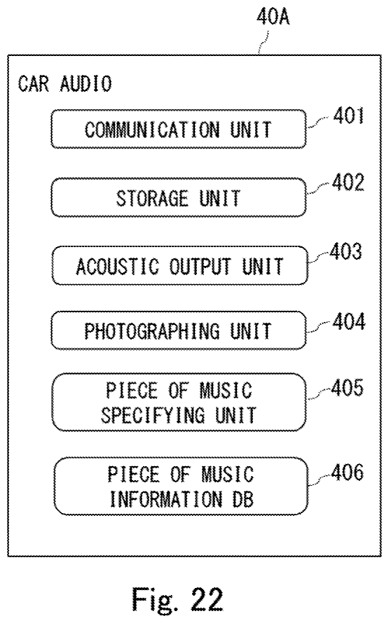

Next, an explanation will be made about the functional configure of the car audio 40A. FIG. 22 shows an exemplary outline of the functional configuration of the car audio 40A. The car audio 40A is provided with functions which are the same as or equivalent to those of the car audio 40. An explanation will be made below about the functions which are provided for the car audio 40A, the functions being different from the functions provided for the car audio 40.

The car audio 40A is provided with a photographing unit 404. The photographing unit 404 controls the photographing operation performed by the camera module 42. Further, the photographing unit 404 transmits photographed image information to a piece of music specifying unit 405 (described later on).

The car audio 40A includes the piece of music specifying unit 405. The piece of music specifying unit 405 distinguishes the object imaged in the image received from the photographing unit 404. A known image recognition technique is used for the distinguishing method. Further, the piece of music specifying unit 405 extracts the information stored in the piece of music information DB 406 (described later on). Then, the piece of music specifying unit 405 specifies the piece of music corresponding to the received image information on the basis of the object inform distinguished from the image received from the photographing unit 404 and the information included in the piece of music information DB 406 (described later on).

The car audio 40A includes the piece of music information DB 406 in which the information relevant to the piece of music is stored. The piece of music information DB 406 is constructed such that the program of the database management system, which is executed by the processor, manages the data stored in the storage unit 402. The piece of music information DB 406 is, for example, a relational database.

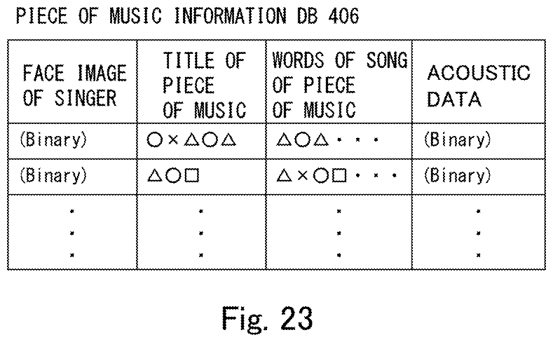

FIG. 23 shows an exemplary outline of a table included in the piece of music information DB 406. As shown in FIG. 23, the piece of music information DB 406 stores therein “face image information of singer”, “title of piece of music information”, “words of song of piece of music information”, and “acoustic information”. Further, the acoustic information may be either a part of or all of the piece of music.

Further, the processor, which is possessed by the car audio 40A for executing the program to realize the functions as described above, is an example of the “controller” of the present disclosure.

### (Process Flow of Car Audio 40A)

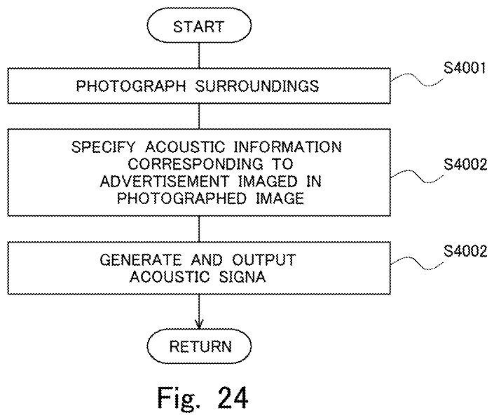

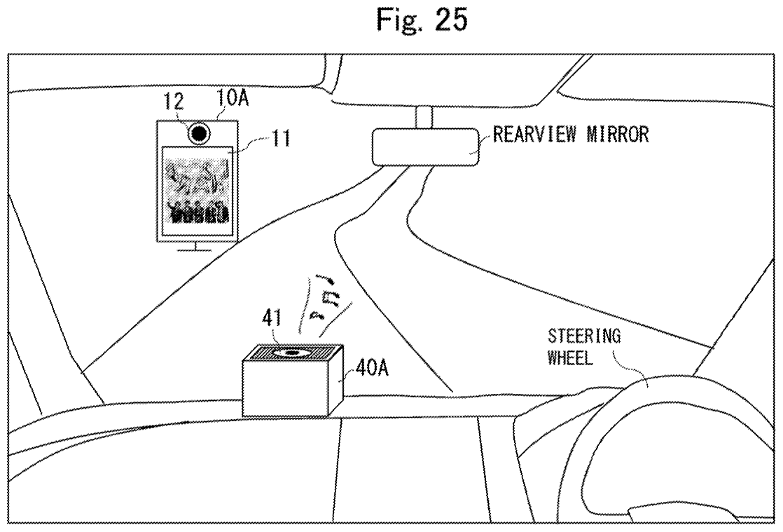

Next, an explanation will be made about a process flow executed by the car audio 40A. FIG. 24 shows an exemplary flow chart for executing a process in which the car audio 40A outputs an acoustic signal of a piece of music relevant to an advertisement displayed on the display 11 of the digital signage 10A. In this context, it is assumed that the advertisement relevant to a new song is displayed on the display 11. Further, it is assumed that, for example, a face of a singer who sings the piece of music, a title of the piece of music, and words of song of the piece of music are displayed. Further, FIG. 25 shows an exemplary outline to depict a situation in which the car audio 40A is installed in the vehicle, and the piece of music relevant to the advertisement displayed on the display 11 resounds throughout the interior of the vehicle by the aid of the car audio 40A. In this case, the car audio 40A is installed on a dashboard in the vehicle so that the camera module 42 is directed to the front of the vehicle.

### (S4101)

In Step S4101, the photographing unit 404 of the car audio 40A executes the photographing operation, and the photographed image is transmitted to the piece of music specifying unit 405.

### (S4102)

In Step S4102, the piece of music specifying unit 405 distinguishes, for example, the face of the singer who sings the piece of music, the title information of the piece of music, and the words of song information of the piece of music, from the object imaged in the image received from the photographing unit 105. In other words, when the vehicle approaches the display 11, the piece of music specifying unit 405 can distinguish, for example, the face of the singer who sings the piece of music, the title information of the piece of music, and the words of song information of the piece of music. Further, the piece of music specifying unit 405 extracts the information stored in the piece of music information DB 406. Then, the piece of music specifying unit 405 specifies the acoustic information corresponding to the face of the singer who sings the distinguished piece of music, the title information of the piece of music, and the words of song information of the piece of music. That is, in this modified embodiment, for example, the face of the singer who sings the piece of music displayed on the display 11, the title of the piece of music, and the words of song of the piece of music are distinguished. The acoustic information, which corresponds to the distinguished information as described above, is specified.

### (S4103)

In Step S4103, the acoustic output unit 403 generates and outputs the signal of the specified acoustic information. That is, as shown in FIG. 25, the sound, which relates to the displayed advertisement, resounds in the vehicle.

Even in the case of the advertisement display system 1C as described above, a person, who, in the vehicle, notices the advertisement relevant to the new song of the singer displayed on the display 11 of the digital signage 10A, recognizes the advertisement of the new song by the aid of the acoustic sense (sense of hearing), in addition to the recognition by the aid of the visual sense (sense of sight), in the same manner as in the second embodiment. That is, the advertisement display system 1C described above makes it possible to enhance the power of the advertisement to appeal to customers.

### Other Embodiments

In the embodiments described above, the examples have been shown, in which the advertisement is recognized by the aid of the olfactory sense or the acoustic sense in addition to the visual sense. However, it is also allowable to provide an advertisement display system in which the advertisement is recognized by the aid of the olfactory sense and the acoustic sense in addition to the visual sense. For example, an advertisement of healing music is displayed on the digital signage, and the blower 20 and the car audio 40 are carried on a vehicle, then an odor, which has a healing effect is allowed to blow into the vehicle from the blower 20, and the healing music can resound in the vehicle from the car audio 40. Even in the case of the embodiment as described above, it is possible to enhance the power of the advertisement to appeal to customers.

The embodiments described above are exemplified by way of example in every sense. The present disclosure may be carried out while appropriately making changes within a range without deviating from the gist or essential characteristics thereof.

Further, the configuration and the processes explained in this disclosure can be carried out while freely combining them unless any technical contradiction or inconsistency arises.

Further, the process, which has been explained as being pertained by one apparatus or device, may be executed by a plurality of apparatuses or devices in a shared manner. Alternatively, the process, which has been explained as being pertained by the different apparatuses or devices, may be executed by one apparatus or device without causing any problem. In the computer system, it is possible to flexibly change the way of realization of the respective functions by means of any hardware configuration (server configuration).

The present disclosure can be also realized such that a computer program, in which the functions explained in the foregoing embodiments are packaged, is supplied to a computer, and the program is read and executed by one or more processors possessed by the computer. The computer program as described above may be provided for the computer by means of any non-transitory computer-readable storage medium capable of being connected to a system bus of the computer, or the computer program may be provided for the computer by the aid of a network. The non-transitory computer-readable storage medium includes, for example, disks of arbitrary types such as magnetic disk (floppy (registered trademark) disk, hard disk drive (HDD) and the like), optical disk (CD-ROM, DVD disk, Blu-ray Disc and the like) and the like, read only memory (ROM), random access memory (RAM), EPROM, EEPROM, magnetic card, flash memory, optical card, and media of arbitrary types suitable for storing electronic commands.

What is claimed is:

1. An information processing apparatus comprising a controller configured to execute:
detecting approach of a vehicle to an advertisement to be displayed; and
providing a stimulus relevant to the advertisement to any one or more of five senses other than a visual sense of a person in the vehicle if the approach of the vehicle to the advertisement is detected.

2. The information processing apparatus according to claim 1, wherein the controller executes displaying the advertisement on a digital signage.

3. The information processing apparatus according to claim 1, wherein:
the advertisement relates to a piece of music; and
the controller executes playing the piece of music in the vehicle.

4. The information processing apparatus according to claim 1, wherein the controller executes causing emission of an odor relevant to the advertisement in the vehicle.

5. The information processing apparatus according to claim 1, wherein the controller executes sending an odor relevant to the advertisement toward the vehicle from a place at which the advertisement is displayed.

6. The information processing apparatus according to claim 1, wherein the advertisement relates to a food and/or a drink, and the controller provides the stimulus to recall the food and/or the drink to the person in the vehicle.

7. The information processing apparatus according to claim 1, wherein the advertisement relates to a plant, and the controller provides the stimulus to recall the plant to the person in the vehicle.

8. An information processing method comprising:
detecting approach of a vehicle to an advertisement to be displayed; and
providing a stimulus relevant to the advertisement to any one or more of five senses other than a visual sense of a person in the vehicle if the approach of the vehicle to the advertisement is detected.

9. A non-transitory storage medium storing a program for allowing a computer to execute:
detecting approach of a vehicle to an advertisement to be displayed; and
providing a stimulus relevant to the advertisement to any one or more of five senses other than a visual sense of a person in the vehicle if the approach of the vehicle to the advertisement is detected.
